(19) United States
(12) Patent Application Publication
(10) Pub. No.: US 2011/0117951 A1
(43) Pub. Date: May 19, 2011

(54) APPARATUS AND METHOD FOR CAMPING ON IN MOBILE COMMUNICATION TERMINAL

(75) Inventor: Sang-Hyun Lee, Seoul (KR)

(73) Assignee: Samsung Electronics Co. Ltd., Suwon-si (KR)

(21) Appl. No.: 12/948,980

(22) Filed: Nov. 18, 2010

(30) Foreign Application Priority Data
Nov. 19, 2009 (KR) 10-2009-0111887

(51) Int. Cl. H04W 72/04

(52) U.S. Cl. 455/513

(57) ABSTRACT

An apparatus and a method for obtaining a service in a weak electric field in a mobile communication terminal are provided. In the method, whether one or more frequencies that meet reception signal strength of a certain threshold exist among all frequencies on which camp-on is possible is determined. When it is determined that the one or more frequencies that meet the reception signal strength of the certain threshold do not exist, camp-on is attempted for one or more frequencies that are expected to exist and have been set in advance.

### PRIORITY

This application claims the benefit under 35 U.S.C. §119(a) of a Korean patent application filed in the Korean Intellectual Property Office on Nov. 19, 2009 and assigned Serial No. 10-2009-0111887, the entire disclosure of which is hereby incorporated by reference.

### BACKGROUND OF THE INVENTION

1. Field of the Invention

The present invention relates to an apparatus and a method for camp-on in a mobile communication terminal. More particularly, the present invention relates to an apparatus and a method for periodically attempting camp-on in order to obtain a service in a mobile communication terminal.

2. Description of the Related Art

Generally, a mobile communication terminal is based on mobility and portability. As the mobile communication terminal is widely distributed, a study for improving Quality of Service (QoS) is in active process. One of the studies is to provide mobility without cutoff of communication.

When a mobile communication terminal moves to a difficult signal reception area (for example, the basement of a building) where reception power is weakened and a weak electric field state is generated while communicating with a base station responsible for a cell at which the mobile communication terminal is located, communication between the mobile communication terminal and the base station usually gets cut off.

To address this issue, conventional mobile communication terminals scan all frequencies at a period of a predefined time and attempt camp-on for one or more frequencies meeting reception signal strength of a certain threshold, thereby obtaining a service.

However, when attempting camp-on using this method, a situation where a mobile communication terminal does not attempt camp-on for a relevant frequency because reception signal strength of a certain threshold is not met at a scanning point, even when the frequency may be used for the camp-on in reality, may occur. In this case, the mobile communication terminal cannot receive a service until it performs scanning on all frequencies again after a predefined time elapses and succeeds in the camp-on.

Therefore, a need exists for an apparatus and a method for obtaining a service by attempting camp-on for one or more frequencies expected to exist at a predefined period even when reception signal strength of a certain threshold is not met.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for camp-on in a mobile communication terminal.

Another aspect of the present invention is to provide an apparatus and a method for obtaining a service in a weak electric field in a mobile communication terminal.

Still another aspect of the present invention is to provide an apparatus and a method for obtaining a service by attempting camp-on for one or more frequencies expected to exist at a predefined period even when reception signal strength of a certain threshold is not met.

In accordance with an aspect of the present invention, a method for camp-on in a mobile communication terminal is provided. The method includes, determining whether one or more frequencies that meet reception signal strength of a certain threshold exist among all frequencies for which camp-on is possible, and, upon determining that one or more frequencies that meet the reception signal strength of the certain threshold do not exist, attempting camp-on for one or more frequencies that are expected to exist and have been set in advance.

In accordance with another aspect of the present invention, an apparatus for camp-on in a mobile communication terminal is provided. The apparatus includes, a frequency manager for setting in advance one or more frequencies that are expected to exist, and a scanning unit for determining whether one or more frequencies that meet reception signal strength of a certain threshold exist among all frequencies for which camp-on is possible, and, when determining that the one or more frequencies that meet the reception signal strength of the certain threshold do not exist, for attempting camp-on for the one or more frequencies that are expected to exist and have been set in advance.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a mobile communication terminal according to an exemplary embodiment of the present invention; and

FIG. 2 is a flowchart illustrating a method for periodically attempting camp-on in order to obtain a service in a mobile communication terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein may be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an alternative for periodically attempting camp-on in order to obtain a service in a mobile communication terminal. More particularly, exemplary embodiments of the present invention provide an alternative for obtaining a service by attempting camp-on for one or more frequencies that are expected to exist at a predefined period even when reception signal strength of a certain threshold is not met in a mobile communication terminal.

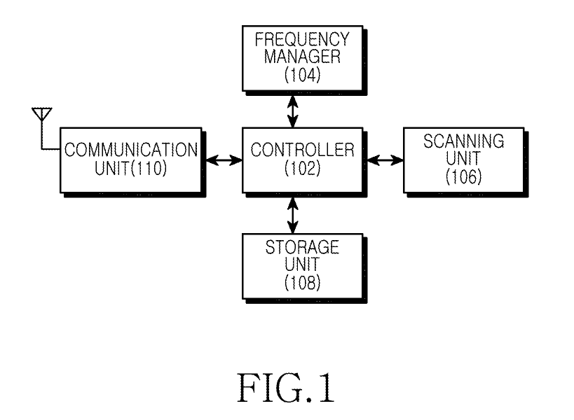

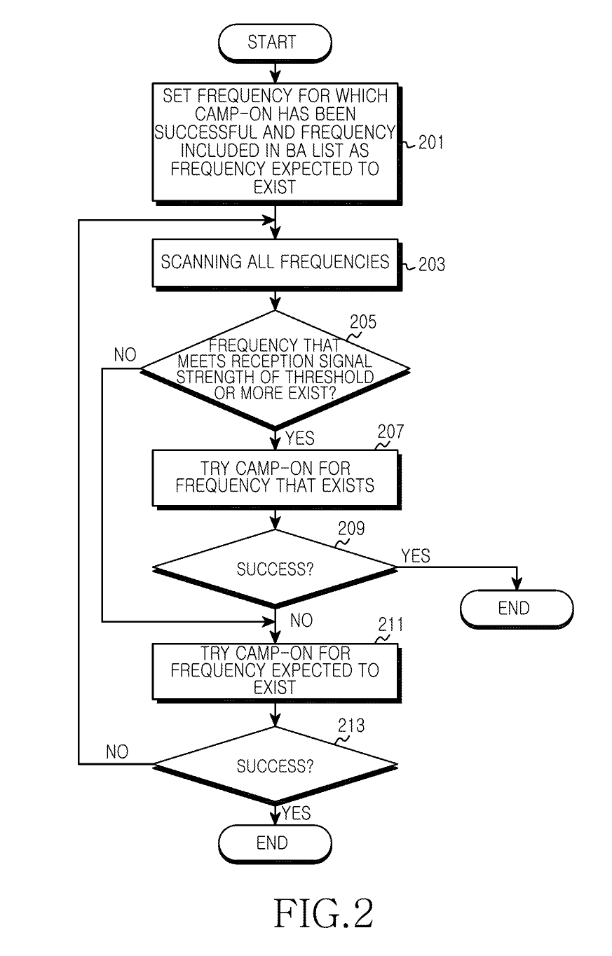

FIGS. 1 and 2, discussed herein, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 1 is a block diagram illustrating a mobile communication terminal according to an exemplary embodiment of the present invention.

Referring to FIG. 1, the terminal includes a controller 102, a frequency manager 104, a scanning unit 106, a storage unit 108, and a communication unit 110.

The controller 102 controls an overall operation of the terminal. For example, the controller 102 processes and controls voice communication and data communication. In addition to the general functions, according to an exemplary embodiment of the present invention, the controller 102 processes a function for periodically attempting camp-on in order to obtain a service. That is, the controller 102 processes a function for obtaining a service by attempting camp-on for one or more frequencies that are expected to exist at a predefined period even when reception signal strength of a certain threshold is not met.

The frequency manager 104 sets at least one of a frequency that has been previously successful in camp-on and a frequency included in a Broadcast Control CHannel (BCCH) Allocation (BA) list, as a frequency that is expected to exist, and stores and manages the same. Here, the BA list denotes a neighbor-cell list that is periodically broadcasted from a serving cell.

The scanning unit 106 performs scanning on all frequencies for which camp-on is possible to measure reception signal strength. As a result of the scanning, the scanning unit 106 determines whether one or more frequencies that meet reception signal strength of a certain threshold exist among all the frequencies for which camp-on is possible. If it is determined that the one or more frequencies that meet reception signal strength of the certain threshold do not exist, the scanning unit 106 attempts camp-on for the set one or more frequencies that are expected to exist. In contrast, if it is determined that the one or more frequencies that meet the reception signal strength of the certain threshold exist, the scanning unit 106 attempts camp-on for the one or more frequencies that are determined to exist. If the camp-on attempted for the one or more frequencies that are determined to exist fails, the scanning unit 106 attempts camp-on for the set one or more frequencies that are expected to exist.

The storage unit 108 stores programs for processes and controls of the controller 102, and data generated during execution of each program. More particularly, according to an exemplary embodiment of the present invention, the storage unit 108 stores a program for periodically attempting camp-on in order to obtain a service.

The communication unit 110 transmits/receives a wireless communication signal via an antenna. For example, the communication unit 110 modulates and up-converts a signal from the controller 102, transmits the same via an antenna, and down-converts and demodulates a Radio Frequency (RF) signal received from the antenna and provides the same to the controller 102.

FIG. 2 is a flowchart illustrating a method for periodically attempting camp-on in order to obtain a service in a mobile communication terminal according to an exemplary embodiment of the present invention.

Referring to FIG. 2, the terminal sets at least one of a frequency that has been previously successful in camp-on and a frequency included in the BA list as a frequency that is expected to exist in step 201. Here, the BA list denotes a neighbor-cell list that is periodically broadcasted from a serving cell.

In step 203, the terminal performs scanning on all frequencies for which camp-on is possible to measure reception signal strength. For example, in a case of a second generation wireless communication technology (2G), all frequencies for which camp-on is possible include nine hundred or more frequencies in a terminal that supports a 4-band. In a case where the terminal detects power-on or moves to a difficult signal reception area where reception power is weakened and a weak electric field is detected, the scanning may be periodically performed at a period of a predefined time, for example.

In step 205, the terminal determines whether one or more frequencies that meet reception signal strength of a certain threshold exist, among all frequencies for which the camp-on is possible as a result of the scanning.

If it is determined in step 205 that the one or more frequencies that meet the reception signal strength of the certain threshold exist, the terminal attempts camp-on for the one or more frequencies that are determined to exist in step 207. Thereafter, the terminal determines whether the camp-on attempted for the one or more frequencies that are determined to exist has been successful in step 209.

In contrast, if it is determined that the one or more frequencies that meet the reception signal strength of the certain threshold do not exist in step 205, the terminal attempts camp-on for the set one or more frequencies that are expected to exist in step 211, and performs subsequent steps.

If it is determined in step 209 that the camp-on attempted for the one or more frequencies that are determined to exist has been successful, the terminal ends the algorithm according to an exemplary embodiment of the present invention.

In contrast, if it is determined in step 209 that the camp-on attempted for the one or more frequencies that are determined to exist has failed, the terminal attempts camp-on for the set one or more frequencies that are expected to exist in step 211. Thereafter, the terminal determines whether the camp-on attempted for the set one or more frequencies that are expected to exist has been successful in step 213.

If it is determined in step 213 that the camp-on attempted for the set one or more frequencies that are expected to exist has been successful, the terminal ends the present algorithm according to an exemplary embodiment of the present invention.

In contrast, if it is determined in step 213 that the camp-on attempted for the set one or more frequencies that are expected to exist has failed, the terminal returns to step 203 and performs subsequent steps after a predefined time.

By doing so, the terminal may prevent a situation where the terminal does not attempt camp-on for a relevant frequency because reception signal strength of a certain threshold is not met at a scanning point, even when the frequency may be used for the camp-on in reality, and so performs scanning for all frequencies for which the camp-on is possible after a predefined time elapses and may not receive a service until the camp-on is successful.

In the above described method, a mobile communication terminal according to an exemplary embodiment of the present invention may obtain a service quickly in a weak electric field, and furthermore, increase a service maintenance time by attempting camp-on for one or more frequencies that are expected to exist at every predefined period even when reception signal strength of a certain threshold is not met.

While the invention has been described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for camp-on in a mobile communication terminal, the method comprising:
determining whether one or more frequencies that meet reception signal strength of a certain threshold exist among frequencies for which camp-on is possible; and
when determining that the one or more frequencies that meet the reception signal strength of the certain threshold do not exist, attempting camp-on for one or more frequencies that are expected to exist and have been set in advance.

2. The method of claim 1, further comprising setting in advance at least one of a frequency that has been previously successful in camp-on and a frequency included in a Broadcast Control CHannel (BCCH) Allocation (BA) list as the one or more frequencies that are expected to exist.

3. The method of claim 2, wherein the BA list denotes a neighbor-cell list that is periodically broadcasted from a serving cell.

4. The method of claim 1, further comprising:
when determining that the one or more frequencies that meet the reception signal strength of the certain threshold exist, attempting camp-on for the one or more frequencies that are determined to exist;
determining whether the camp-on attempted for the one or more frequencies that are determined to exist has been successful; and
when determining that the camp-on attempted for the one or more frequencies that are determined to exist has failed, attempting camp-on for the one or more frequencies that are expected to exist and have been set in advance.

5. The method of claim 1, further comprising performing scanning on all frequencies for which camp-on is possible to measure reception signal strength.

6. An apparatus for camp-on in a mobile communication terminal, the apparatus comprising:
a frequency manager for setting one or more frequencies that are expected to exist; and
a scanning unit for determining whether one or more frequencies that meet reception signal strength of a certain threshold exist among frequencies for which camp-on is possible, and, when determining that the one or more frequencies that meet the reception signal strength of the certain threshold do not exist, attempting camp-on for the one or more frequencies that are expected to exist and have been set in advance.

7. The apparatus of claim 6, wherein the frequency manager sets in advance at least one of a frequency that has been previously successful in camp-on and a frequency included in a Broadcast Control CHannel (BCCH) Allocation (BA) list as the frequency that are expected to exist.

8. The apparatus of claim 7, wherein the BA list denotes a neighbor-cell list that is periodically broadcasted from a serving cell.

9. The apparatus of claim 6, wherein the scanning unit attempts camp-on for the one or more frequencies that are determined to exist when determining the one or more frequencies that meet the reception signal strength of the certain threshold exist, determines whether the camp-on attempted for the one or more frequencies that are determined to exist has been successful, and attempts camp-on for the one or more frequencies that are expected to exist and have been set in advance when determining that the camp-on attempted for the one or more frequencies that are determined to exist has failed.

10. The apparatus of claim 6, wherein the scanning unit performs scanning on all frequencies for which the camp-on is possible to measure reception signal strength.
